(19) United States
(12) Patent Application Publication
(10) Pub. No.: US 2007/0172686 A1
(43) Pub. Date: Jul. 26, 2007

(54) Polarized plate

(75) Inventors: Kuang-Rong Lee, Taoyuan (TW); Ying-Da Tzeng, Taoyuan (TW); Tan-Ching Wang, Taoyuan (TW); Yi-Jen Lin, Taoyuan (TW); Yu-Hwey Chuang, Taoyuan (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: OPTIMAX TECHNOLOGY CORPORATION, Ping Chen (TW)

(21) Appl. No.: 11/474,808

(22) Filed: Jun. 26, 2006

(30) Foreign Application Priority Data
Jan. 24, 2006 (TW) 095201617

(51) Int. Cl. B32B 27/32

(52) U.S. Cl. 428/523

(57) ABSTRACT

A polarized plate includes a polarized layer, a first optical film located on a upper side of the polarized layer and a second optical film located on a lower side of the polarized layer. At least one of the first and second optical films is made from Polymethyl Methacrylate (PMMA). The optical films are formed by dispensing a mixed solution on a substrate, then bonding to the polarized layer and processed through a heat treatment. The optical films may also be formed by dispensing the mixed solution on the surface of the polarized layer and processed through a heat treatment.

### BACKGROUND OF THE INVENTION

1. Field of the Invention

The present invention relates to a method for manufacturing an optical film by mixing with optical polymers and particularly to a method for manufacturing a Polymethyl Methacrylate (PMMA) optical film through a solvent-casting process of film.

2. Description of the Prior Art

A conventional polarized plate usually consists of a polarized substrate and an optical film located respectively on a upper surface and a lower surface thereof. The optical film mainly is made from triacetate (TAC), polycarbonate (PC), cycloolefin polymer (COP) or the like. A typical TAC film further provides the functions of protecting and bracing the optical film. Hence the general TAC film, aside from having required optical characteristics, also must have a sufficient strength and withstand high temperature and humidity (reference can be found in patents such as JP4342202, TW499573, JP2000-324055, JP2001-235625, JP2003-195048, EP1-285742 and EP1-331245). U.S. Pat. No, 6,652,926 B1 also discloses a technique that uses TAC containing 0.04% to 0.3% of silica particles to enhance the toughness and reduce the thickness of the TAC film.

The techniques for producing the substrate or protection film can also be found in U.S. patent publication No. 2004/0086721A1. It proposes to fabricate the substrate or protection film by melting-mixed processing that include 20-40% of PVDF, 40-60% of PMMA and 5-18% of acrylic elastomer. EP1154005A1 also discloses a technique that mixes micro particles smaller than 5 um in a PET film to reach a coarseness between 20-600 nm. Japan patent No. 7-56017 discloses a technique for forming a film of 80 um by casting 80% of PC and 20% of Kuraray C-16, and a film of 500 um by mixing PMMA(MMA97% plus BA3%) 75% with polyethyleneterephthalate(PET) 25%.

All the TAC films made from the techniques mentioned above have a common drawback, namely they absorb water and have a great moisture permeability. When used in a high temperature and high humidity condition, the film tends to deform or generate stress due to external environment, and the optical characteristics of the optical film are affected. In serious cases, the optical film could even become useless. Moreover, the b-value of TAC is too high. It is visible from the appearance, and tends to hinder visibility. In addition, COP film (such as Zeonor, Arton and the like) has too small of water absorption and moisture permeability. As a result, its adherence capability suffers, and it becomes too brittle. EU patent No. EP1154005A1 discloses a technique which provides micro particles to reduce the surface coarseness. But the glass transformation temperature of the PET being used is too low (75° C.), and cannot withstand the temperature required by the optical film now being used. Japan patent No. 7-56017 discloses a PMMA/PC mixture which is too brittle, and the PMMA/PEA mixture has a thickness of 500 um. It is not desirable for the optical film.

In view of the aforesaid disadvantages, and to prevent material unstableness caused by melting-mixed processing or thermoplastic fabrication, and improve heat-resistance, moisture-resistance and mechanical characteristics of the optical film to enhance the stability of the optical film, the present invention aims to provide a polarized plate.

### SUMMARY OF THE INVENTION

The primary object of the present invention is to provide a polarized plate that contains PMMA and is formed through a solvent-casting process of film. The PMMA is solvable in a non-toxic solvent such as methylbenzene. Hence there is no need to consume a great amount of methane dichloride in the manufacturing process of TAC. As a result, it is less harmful to human body and the environment.

It is another object of the invention is to provide a polarized plate that has desirable water absorption and moisture permeable properties to eliminate degradation of optical characteristics that might otherwise occur to the polarized plate.

It is a further object of the invention to provide a polarized plate that is heat-resistant, and has desirable mechanical characteristics and a lower photoelastic coefficient and desirable optical characteristics, such as a lower haze, a smaller yellowness index, and a higher Abbe's number. It has a higher penetrability (>90%) in the range of visible light (wavelength between 400-700 nm) and uniform film surface characteristics (such as thickness, surface coarseness, and the like), and can prevent the unstable material condition caused by melting-mixed processing or thermoplastic fabrication.

The polarized plate of the invention made from mixed PMMA through solvent-casting process of film has many benefits, including 1. improved heat-resistance, desirable mechanical characteristics, lower photoelastic coefficient and desirable optical characteristics such as a higher transparency, a lower haze, a smaller yellowness index, and a higher Abbe's number, and a higher penetrability (>90%) in the range of visible light (wavelength between 400-700 nm and uniform film surface characteristics (such as thickness, surface coarseness, and the like); 2. prevent unstable material condition caused by melting-mixed processing or thermoplastic fabrication; 3. a desirable moisture permeability and water absorption capability to eliminate degradation of optical characteristics of the optical film; 4. a simpler manufacturing process; 5. a lower photoelastic coefficient; 6. abundant material supply (resin) at a lower cost; and 7. reduce PVA internal shrinkage at high temperature and humidity.

The polarized plate according to the invention includes a polarized layer, a first optical film located on a upper side of the polarized layer and a second optical film located on a lower side of the polarized layer. At least one of the first and the second optical films is made from PMMA.

In one aspect, the optical film is formed by dispensing a mixed solution on a substrate, bonded to the polarized layer and processed through a heat treatment. Or the mixed solution is coated on the surface of the polarized layer and a heat treatment is processed to form the optical film. The optical film thus formed contains at least PMMA, PMMA with a substituted functional group, or a mixture of PMMA and a solvent that is a uniform mixed solution to be coated evenly on the substrate; then is processed through a heat treatment to form a uniform optical film on the surface.

The first functional group is methyl, and the second functional group is selected from the group consisting of ethyl, propyl, isopropyl, butyl, isobutyl, tert-butyl, hexyl, isohexyl and cyclohexyl. The mixture includes at least a polymer, small molecule, plasticizer, UV absorbent, antidegradant, or nano particles. The solvent includes at least an aromatics, cycloparaffin group, ether group, ester group, or ketone group. The aromatics comprise methylbenzene or o-, m-, p-xylene. The cycloparaffin group includes Cyclohexane. The ether group includes Diehtyl ether and Tetrahydrofuran (THF). The ester includes Methyl acetate and Ethyl acetate. The ketone group includes Acetone, methylethylketone (MEK) and 1-methylpyrrolidone (NMP).

The mixed solution is coated evenly on the substrate through a solvent-casting process of film. The technique includes dispensing through a scraper, winding stick coating, coating through a positive turning roller or an inverse turning roller, coating by air curtain, coating by a wheel, coating by an embossed barrel, coating by submerging, rotary coating, slit coating, squeeze coating, shower coating or the like. The substrate includes a glass plate, plastic plate, steel plate with a mirror plane, steel belt with a mirror plane or synthetic polymers with a desirable uniform surface. The synthetic polymers include PET (polyethyleneterephthalate), PEN (polyethylenenaphthalate), PES (polyethersulfone), PI (polyimide), PAR (polyarylate), PC (polycarbonate) or natural fibers such as CA (cellulose acid), DAC(cellulose diacetate), TAC(cellulose triacetate) or the like. The mixed solution is evenly coated on the substrate at a thickness between 150 um and 1200 um. Projecting UV on the mixed solution coated evenly on the substrate does the heat treatment.

Furthermore, PMMA and/or PMMA with substituted functional group and/or PMMA elastic rubber particles formed by mixing PMMA with an elastic rubber material may be added to the optical film of the invention. The elastic rubber material may be selected from butyl-acrylate, methyl methacrylate, styrene and polymers thereof. The elastic rubber particles are formed at a size smaller than 10 um or even at a nanometer dimension to enhance the mechanical characteristics of the optical film.

### BRIEF DESCRIPTION OF THE DRAWINGS

FIG. 1 is a perspective view of an embodiment of the polarized plate of the invention;

FIG. 2 is a manufacturing flow chart for an embodiment of the polarized plate of the invention;

FIG. 3 is a comparing chart showing alterations of monomer penetrability of a conventional polarized plate and the polarized plate of the invention;

FIG. 4 is a comparing chart showing polarization alterations of a conventional polarized plate and the polarized plate of the invention; and

FIG. 5 is a comparing chart showing PVA internal shrinkage of a conventional polarized plate and the polarized plate of the invention.

### DESCRIPTION OF THE PREFERRED EMBODIMENTS

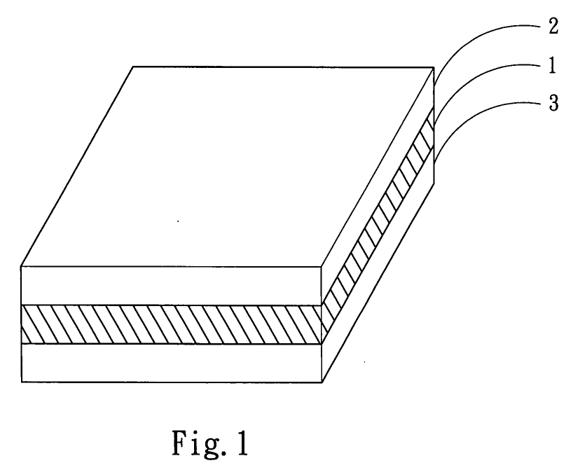

Refer to FIG. 1 for an embodiment of the invention. The polarized plate of the invention mainly includes a polarized layer 1, a first optical film 2 located on a upper surface of the polarized layer 1 and a second optical film 3 located on a lower surface of the polarized layer 1. At least one of the upper optical film 2 and the lower optical film 3 is made from PMMA.

Aside from PMMA to make one of the first and second optical films 2 and 3, another optical film may be made from triacetate (TAC), polycarbonate (PC) or cycloolefin polymer (COP) to brace or protect the polarized layer 1.

The PMMA to fabricate the optical film includes PMMA, PMMA with a substituted functional group, or a mixture of a plurality of PMMAs.

The TAC in this invention mainly is selected from KC8U made by Konica Co. and TDY-80 made by Fuji CO.

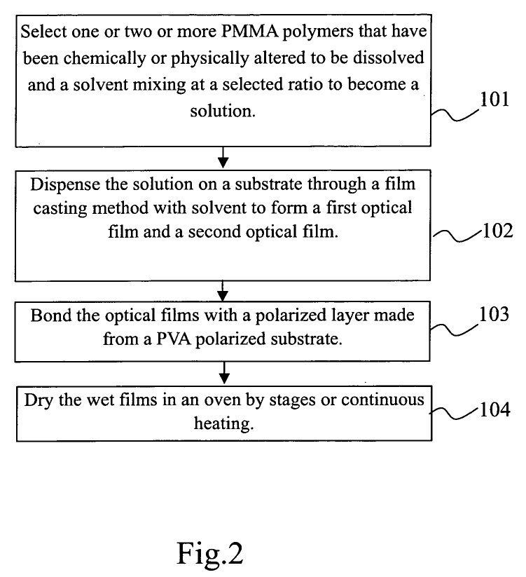

Refer to FIG. 2 for a manufacturing flow chart for an embodiment of the polarized plate of the invention. First, at step 101, select a PMMA polymer and a solvent; namely select one or two or more PMMAs, or a PMMA altered by a chemical/physical process, and evenly dissolve the PMMA in the solvent according to a required ratio to become a solution. According to a preferable condition, the PMMA in the solution contains 20-40% by weight. For instance, the PMMA may have the functional group substituted through a chemical approach, such as the methyl being substituted by ethyl, propyl, isopropyl, butyl, isobutyl, tert-butyl, hexyl, isohexyl and cyclohexyl, or the PMMA may be mixed through a physical approach with at least one type of polymer, smaller molecules, plasticizer, UV absorbent, antidegradant, or nano particles. The solvent includes at least an aromatics, cycloparaffin, ether group, ester group, or ketone group. The aromatics comprise methylbenzene or o-, m-, p-xylene. The cycloparaffin group includes Cyclohexane. The ether group includes Diehtyl ether and Tetrahydrofuran (THF). The ester includes Methyl acetate and Ethyl acetate. The ketone group includes Acetone, methylethylketone (MEK) and 1-methylpyrrolidone (NMP). The solvents mentioned above are only an embodiment, and are not the limitation of the invention.

An embodiment is discussed below with four groups of solvents to form formulas to produce the PMMA optical films through the solvent-casting process of film.

1. Degussa 8N 100 part, Toluene 200 part;

2. Degussa 8N 97.5 part, Kuraray GR 2.5 part, Acetone 200 part;

3. Degussa 8N 80 part, Degussa zk 20 part, methyl acetate 200 part; and

4. Degussa 8N 50 part, Kuraray GR 50 part, Toluene 200 part.

The kuraray GR can be selected from GR04940, GR04970, GR00100, GR01240, GR01270, GR GR1000H24, GR1000H42 and GR1000H60, and may also be substituted by any of Degussa zk3BR, zk4BR, zk5BR, zk6BR, zk4HC, zk5HC, zk6HC, zk5HT, zk6HT, zkHF, zk6HF, zk20, zk30, zk40 and zk50.

At step 102, the solvents are evenly mixed and dispensed on a substrate through the solvent-casting process of film to produce the fist optical film 2 and the second optical film 3. The substrate may be, but not limited to, a glass plate, plastic plate, steel plate with a mirror plane, steel belt with a mirror plane, or a polymer with an even surface. The polymer may include PET, (polyethyleneterephthalate), PEN (polyethylenenaphthalate), PES (polyethersulfone), PI (polyimide), PAR (polyarylate), PC (polycarbonate) or natural fibers such as CA (cellulose acid), DAC(cellulose diacetate), TAC(cellulose triacetate) or the like. At step 102, the mixed solution is dispensed on the glass plate through a scraper. The scraper has a gap of 550 um, 650 um, 400 um or the like. The solvent-casting process of film dispenses the solution through a winding rod, coating through a positive turning roller or inverse turning roller, coating by air curtain, coating by a wheel, coating by an embossed barrel, coating by submerging, rotary coating, slit coating, squeeze coating, shower coating or the like to form a uniform optical film.

The first and second optical films 2 and 3, aside from being formed through various methods of the film casting technique previously discussed, may also be formed by compression or injection with a mirror plane mold.

After the optical films have been produced, at step 103, bond the optical films to the polarized layer 1 made from PVA polarized substrate.

The film coated with the solvent is called a wet film. The thickness of the wet film varies according to different requirements. The preferable thickness is ranged from 150 um to 1200 um. After bonding, proceed step 104 to dry the wet film in an oven by stages or continuously (such as projecting by UV). The drying condition is preferably to leave not greater than 1% of residual solvent. The first and second optical films 2 and 3 thus formed have desired optical characteristics and an even film surface (they are called dry films as oppose to the wet film). The thickness of the first and second optical films 2 and 3 may be controlled by the ratio of the solvent and the heating time and temperature. The dry films may further be treated on the surface through a chemical process to improve dispersion of the solution. This aims to enhance temperature resistance of the film without affecting optical uniformity.

One of applicable approaches at the process of heating by stage previously discussed is to heat the PMMA-contained solution to 90° C. and blend thoroughly for one hour. After the particles are fully dissolved, remove the heat and blend until reaching room temperature. Next, filter the solution through a sieve of 35 um, and keep the sieved solution in a still condition for a selected time period. Then pour the mixed solution onto the glass plate, and remove extra dispensed solution through a scraper with a gap of 550 um. Next, place the coated glass plate in an oven for ten minutes in a still manner, heat to 80° C. for 20 minutes; raise the temperature for additional 20° C. for 20 minutes at one stage until reaching 160° C. for 30 minutes; finally heat to 180° C. for two hours. The optical films thus formed have residual solution of 0.1%, and a thickness of 94 um. Then an optical test and mechanical test may be performed. The optical test focuses on penetrability, Haze, b value and the like, while the mechanical test focuses on extensibility (%), tensile strength (MPa), tensile modulus (MPa) etc.

Moreover, discotic liquid crystals may be coated on the optical film to perform alignment process by employing roller friction or UV exposing, thereby forming a retardation optical film with a phase difference.

In addition, the optical film (dry film) fabricated by means of the method set forth above has desired optical characteristics, such as lower haze and lower yellowness index, a higher light penetrative degree (>90%) in the range of visible light (wavelength between 400-700 um) and higher Abbe's number (namely less dependent on the wavelength).

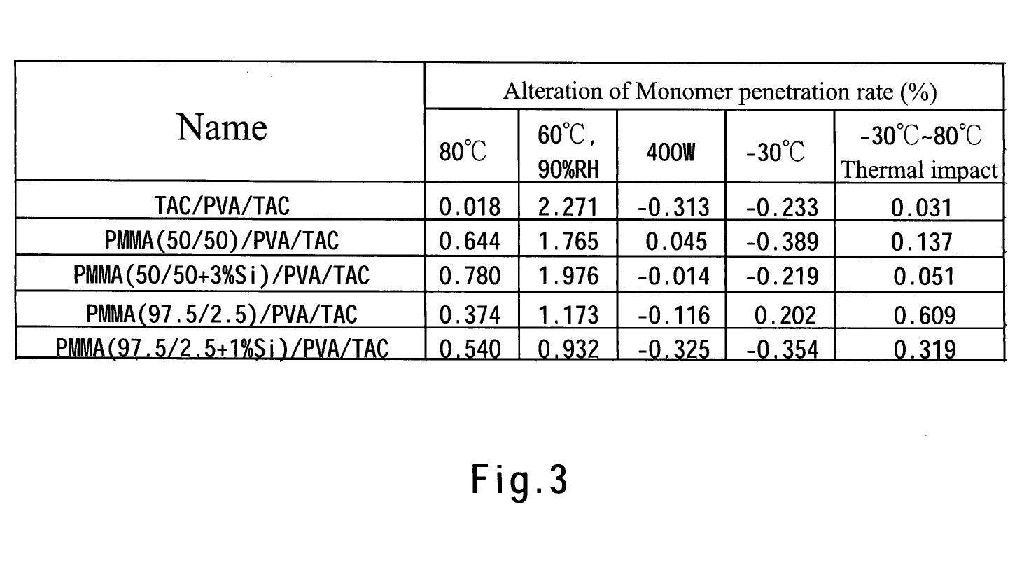

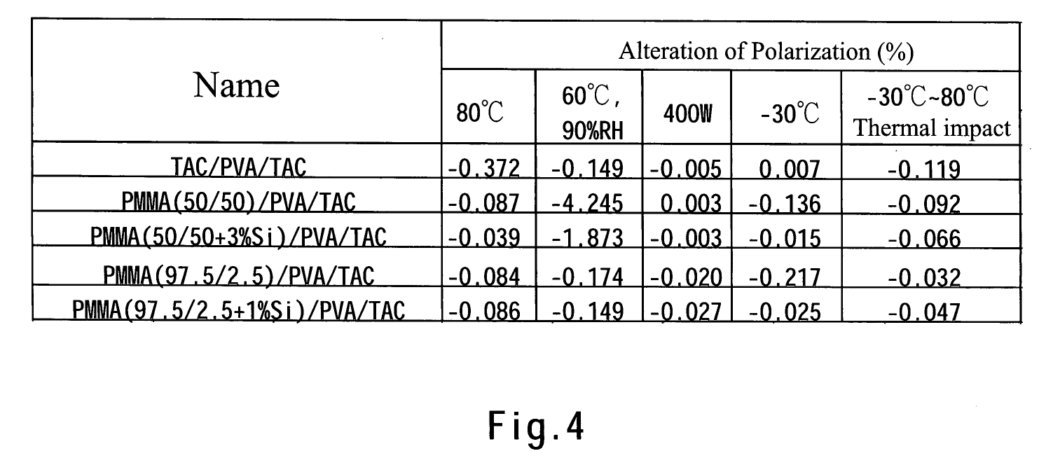

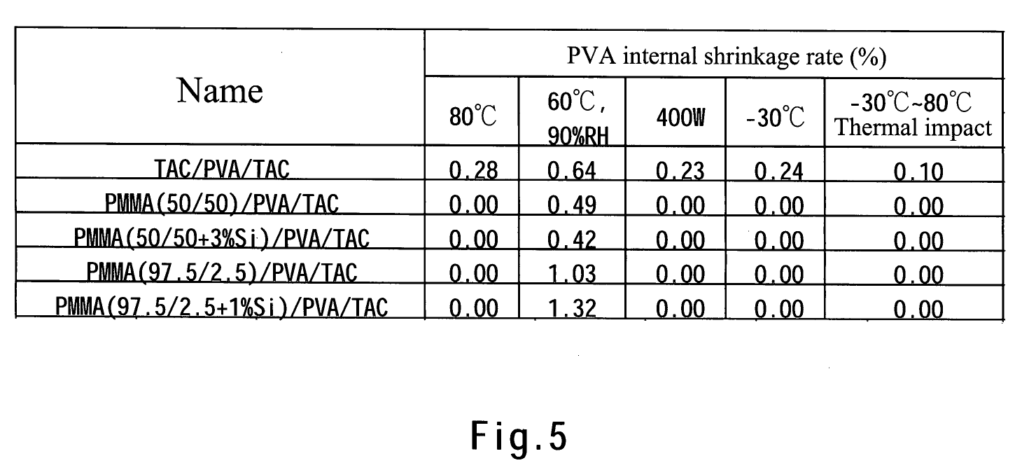

Refer to FIG. 3 for a comparing chart of alterations of monomer penetrability of a conventional polarized plate and the polarized plate of the invention, FIG. 4 for a comparing chart of polarization alterations of a conventional polarized plate and the polarized plate of the invention, and FIG. 5 for a comparing chart of PVA internal shrinkage of a conventional polarized plate and the polarized plate of the invention. The TAC is selected from KC8U of Konica Co. and TDY-80 of Fuji Co. The PMMA and/or PMMA with substituted functional group and/or PMMA elastic rubber particles formed by mixing PMMA with an elastic rubber material may be added to the first and second optical films 2 and 3 of the invention. The elastic rubber material may be selected from butyl acrylate, methyl methacrylate, styrene and polymers thereof. The elastic rubber particles are formed at a size smaller than 10 um or at a nanometer dimension. The adding amount of the PMMA rubber particles is 2.5-50%. The monomer penetrability, polarization alterations and PVC internal shrinkage of the optical films are tested in the various conditions of 80° C., 60° C. at 90% RH, 400 W, −30° C. and thermal impact at −30° C. to 80° C. The results show that improved mechanical characteristics such as enhanced extensibility are obtained for the optical films.

For selecting the optical films previously discussed, the PVA internal shrinkage of the optical films may be smaller than 2%. The optimal PVA internal shrinkage is less than 1.2%.

In addition, silica may be added to the first and second optical films 2 and 3 during the manufacturing process of the optical films. It is preferably to mix the solvent with the silica in advance, then proceed the follow-on mixing process of PMMA. Mixing of the silica may also be included in the mixing process of PMMA particles by adding silica and PMMA together. Adding of silica may also be done after the PMMA has been mixed. The content of silica is preferably in the range of 0.5% to 15% of the optical films by weight.

In the manufacturing and bonding processes of the optical films previously discussed, the polarized layer 1 may be directly served as the substrate of the first and second optical films 2 and 3. Namely directly dispense PMMA-mixed solution on the surface of the polarized layer 1, then proceed the drying processes for the wet film to form the first and second optical films 2 and 3 on the surfaces of the polarized layer 1.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A polarized plate, comprising:
a polarized layer;
a first optical film located on a upper side of the polarized layer; and
a second optical film located on a lower side of the polarized layer;
wherein at least one of the first optical film and the second optical film is made from Polymethyl Methacrylate (PMMA).

2. The polarized plate of claim 1, wherein the first optical film is a PMMA film, the second optical film is made from the group consisting of triacetate (TAC), polycarbonate (PC) and cycloolefin (COP);
wherein the PMMA optical film is made from a PMMA, a PMMA having its functional group being substituted or a PMMA mixing with a selected material and a solvent corresponding to the selected PMMA, the PMMA having its functional group being substituted and the PMMA mixing with a selected material that are mixed according to a selected ratio to meet a requirement to become a mixed solution which is processed through a heat treatment to form the optical film.

3. The polarized plate of claim 2, wherein the PMMA, the PMMA with a substituted functional group or the PMMA mixing with a selected material is mixed with the solvent at a ratio of 20% to 40% by weight.

4. The polarized plate of claim 2, wherein the finctional group in the PMMA to be substituted is methyl, the functional group to substitute the methyl of the PMMA is selected from the group consisting of ethyl, propyl, isopropyl, butyl, isobutyl, tert-butyl, hexyl, isohexyl and cyclohexyl and combinations thereof.

5. The polarized plate of claim 2, wherein the solvent is selected from the group consisting of aromatics, cycloparaffin group, ether group, ester group and ketone group;
wherein the aromatics comprise methylbenzene or o-, m-, p-xylene; the aromatics is selected from one of methylbenzene and o-, m-, p-xylene; the cycloparaffin group is selected from Cyclohexane; the ether group is selected from Diehtyl ether or Tetrahydrofuran (THF); the ester is selected from Methyl acetate or Ethyl acetate; and the ketone group is selected from Acetone, methylethylketone (MEK) or 1-methylpyrrolidone (NMP).

6. The polarized plate of claim 1, wherein the optical films are formed at a thickness between 20 um and 200 um.

7. The polarized plate of claim 1, wherein the optical films include an additive which is selected from the group consisting of a PMMA, a PMMA with a substituted functional group and PMMA elastic rubber particles formed by mixing the PMMA with an elastic rubber material.

8. The polarized plate of claim 7, wherein the elastic rubber material is selected form the group consisting of butyl acrylate, methyl methacrylate, styrene and polymers thereof.

9. The polarized plate of claim 7, wherein the particles of the elastic rubber material are smaller than 10 um.

10. The polarized plate of claim 7, wherein the particles of the elastic rubber material are at a dimension of nanometer.

11. The polarized plate of claim 7, wherein the content of the additive of the PMMA, the PMMA with substituted functional group or the PMMA elastic rubber particles formed by mixing PMMA with an elastic rubber material is at ratio of 2.5% to 5% by weight.

12. The polarized plate of claim 2, wherein the optical films contain silica.

13. The polarized plate of claim 12, wherein the silica content is ranged from 0.5% to 15% of the optical films by weight.

14. The polarized plate of claim 12, wherein the silica is mixed with the solvent in advance before being mixed with the PMMA.

15. The polarized plate of claim 12, wherein the silica is mixed with the PMMA particles while the solvent is added.

16. The polarized plate of claim 12, wherein the silica is added and mixed after the PMMA has been mixed.

17. The polarized plate of claim 2, wherein the optical films are formed by solvent-casting process and dispensing the mixed solution on a substrate to bond the polarized layer that are processed through a heat treatment.

18. The polarized plate of claim 17, wherein the mixed solution is dispensed on the substrate through a scraper, the solvent-casting process of film being accomplished through a group of methods consisting of a scraper, a winding rod, coating through a positive turning roller or an inverse turning roller, coating by air curtain, coating by a wheel, coating by an embossed barrel, coating by submerging, rotary coating, slit coating, squeeze coating, shower coating, compression forming and injection forming;
the substrate being selected from the group consisting of a glass plate, a plastic plate, a steel plate with a mirror plane, a steel belt with a mirror plane and a synthetic polymer with an even surface;
the synthetic polymer being selected from the group consisting of PET, PEN, PES, PI, PAR, PC and natural fibers; the natural fibers being selected from the group consisting of CA, DAC and TAC.

19. The polarized plate of claim 18, wherein the heat treatment is performed by projecting a UV light to the mixed solution on the substrate.

20. The polarized plate of claim 1, wherein the optical films have a PVA internal shrinkage alteration rate smaller than 2%.
